(19) United States
(12) Patent Application Publication
(10) Pub. No.: US 2011/0265305 A1
(43) Pub. Date: Nov. 3, 2011

(54) METHOD OF MANUFACTURING AN OPTICAL DETECTION DEVICE

(75) Inventors: Enzo Mario Di Fabrizio, Roma (IT); Maria Laura Coluccio, Catanzaro (IT); Federico Mecarini, Viterbo (IT); Francesco De Angelis, Roma (IT); Gobind Das, Catanzaro (IT); Patrizio Candeloro, Pescara (IT); Giovanni Cuda, Catanzaro (IT)

(73) Assignee: CALMED S.r.l., Catanzaro (IT)

(21) Appl. No.: 13/143,702

(22) PCT Filed: Dec. 31, 2009
(86) PCT No.: PCT/IB2009/056004

§ 371 Date: Jul. 7, 2011

(30) Foreign Application Priority Data
Jan. 7, 2009 (IT) TO2009A000001

(51) Int. Cl. B23P 11/00

(52) U.S. Cl. 29/428

(57) ABSTRACT

Method for manufacturing an optical detection device includes producing metal nanospheres on a substrate (2). The process also includes the following operations: producing (100) on the substrate (2) lithographic nanostructures (4a, 4b, 4c) capable of receiving the metal nanospheres,—performing (102) a self-aggregative deposition of at least one metal in such a way as to create a respective metal nanosphere in each lithographic nanostructure (4a, 4b, 4c).

This invention relates to a method for manufacturing an optical detection device for detection systems based on spontaneous emissions, such as for example fluorescence or Raman detection systems.

More specifically, the invention relates to a method for the manufacturing of a detection device having a plurality of metal nanospheres which are capable of supporting an emission coupled to surface plasmons.

There are a number of devices which base their operation on the generation of surface plasmons. Surface plasmons are a particular electromagnetic field which is generated on the surface of a noble metal, such as for example gold and/or silver, when illuminated with a laser in the visible light or near ultraviolet.

This effect is due to the fact that these metals no longer behave in an ideal way, but the electrons within them acquire an oscillating frequency (plasma frequency) close to that of the external laser field. In addition to this, their dielectric constant becomes negative and it is therefore possible to generate the propagation of a highly localised electromagnetic field on the metal, in particular on the surface of the metal up to a depth close to the “skin depth”.

Being of a local nature, the plasmon field may be very intense and may be used to create devices for detecting even individual molecules.

American Patent U.S. Pat. No. 7,397,043 B2 describes a system having a detection platform which includes dielectric nanospheres coated with a thin metal layer which is capable of establishing surface plasmon resonance at the operating wavelength of the system.

By the term nanospheres is meant spheres having a radius of less than 100 nm.

The nanospheres contribute to increasing the level of excitation and the efficiency with which emission radiation is collected.

An object of the present invention is to provide a new method for manufacturing a detection device having a plurality of nanospheres.

This and other objects are achieved by a method whose characteristics are defined in claim 1.

Particular embodiments are the subject of the dependent claims, the contents of which are to be understood as an integral and integrating part of this description.

Further features and advantages of the invention will become apparent from the following detailed description, given purely by way of a non-limitative example, with reference to the appended drawings, in which:

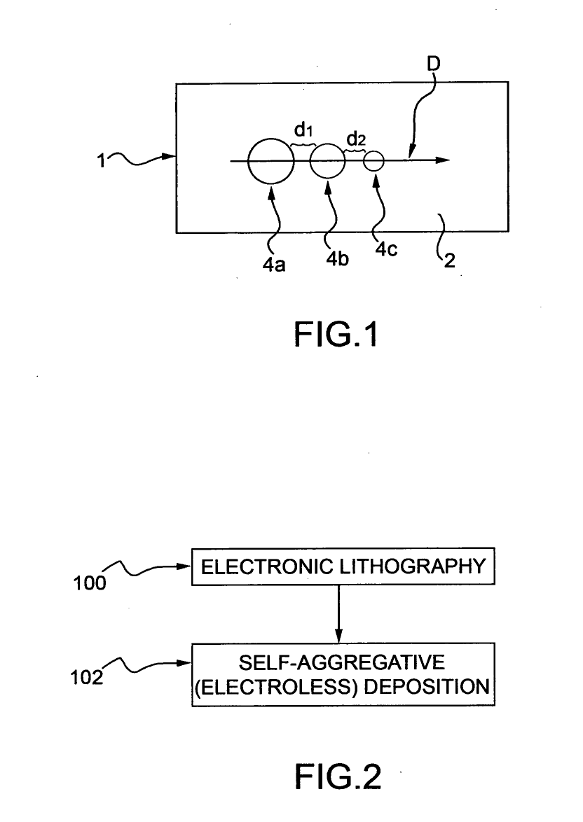

FIG. 1 is a top view of a device according to the invention;

FIG. 2 is a flow diagram of the operations according to the method of the invention; and

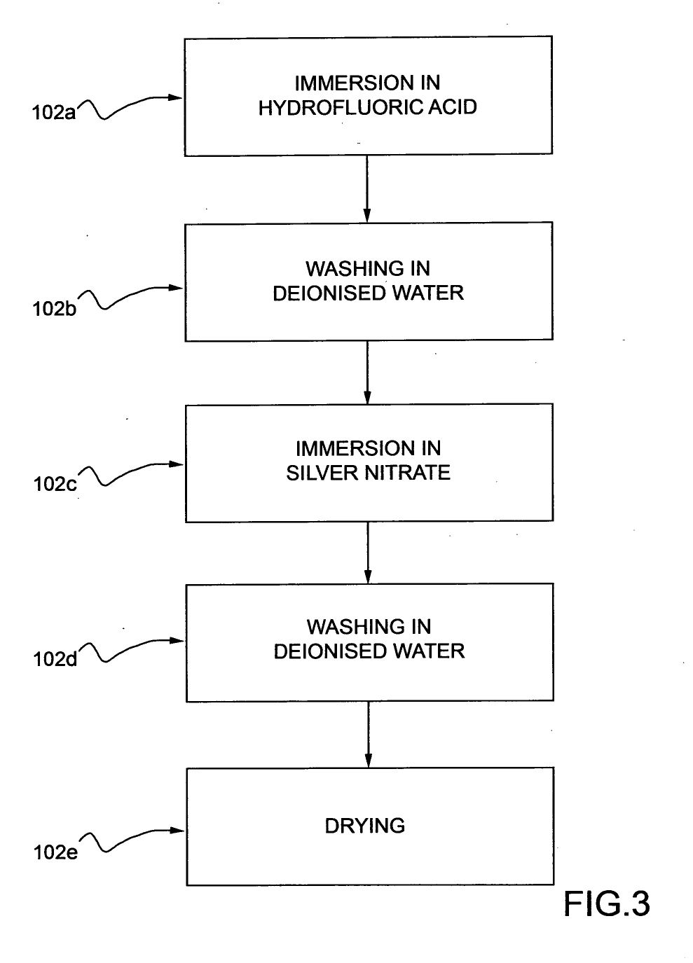

FIG. 3 is a flow diagram of the stages performed during one of the operations in FIG. 2.

In FIG. 1, the device according to the invention is generically indicated by 1. This device 1 comprises a substrate 2, for example silicon, on which there are a plurality of nanostructures 4a, 4b and 4c. In particular there are three spherical nanolenses arranged in line along a direction D, in which the first nanolens 4a and the second nanolens 4b are spaced apart respectively by a first distance d1, for example 40 nm, while the second nanolens 4b and third nanolens 4c are spaced apart respectively by a second distance d2, less than first distance d1, for example 5 nm. The three nanolenses 4a, 4b and 4c preferably have respective radii of 90 nm, 45 nm and 10 nm.

FIG. 2 illustrates a flow diagram of the operations performed to obtain a detection device according to the invention.

As a first operation 100, a stage of high resolution electronic lithography is performed on substrate 2 to construct nanolenses 4a, 4b and 4c.

Subsequently, in step 102, self-aggregative (electroless) deposition of a metal is performed, preferably a noble metal such as for example silver or gold. In this way an oxidation-reduction reaction of the metal is performed, which creates a respective nanosphere of metal within each nanolens 4a, 4b and 4c. This self-aggregative deposition comprises a plurality of successive stages illustrated in the flow diagram in FIG. 3.

In a first stage 102a lithographic substrate 2, hereinafter referred to as the sample, is immersed in a predetermined aqueous solution of hydrofluoric acid, for example 0.15 M, for a predetermined time at a predetermined temperature, in particular for one minute at 50° C. in the case of the deposition of silver nanospheres or one minute at 45° C. in the case of the deposition of gold nanospheres.

In a second stage 102b the sample is washed with deionised water to eliminate the residues of hydrofluoric acid.

In a third stage 102c the sample is immersed in a predetermined solution, for example an aqueous solution of a silver salt, for example AgNO₃, of the order of 1 mM, for a predetermined time at a predetermined temperature, in particular for 30 sec at 50° C., or in a solution of gold salt, for example comprising gold sulphites, of the order of 10 mM, for three minutes at 45° C.

In a fourth stage 10d a further washing of the sample in deionised water is performed to block the reaction producing silver or gold nanospheres.

Finally, the sample is dried with a flow of nitrogen in step 102e.

The immersion of the lithographed sample in hydrofluoric acid, 102a, is aimed at removing the oxide which is naturally present on the substrate 2, leaving a surface which is inert to reactions with oxygen and its compounds, for example O₂, CO₂ or CO, and which is thus available for the subsequent stages of self-aggregative deposition.

If the substrate 2 is of silicon, which becomes silicon oxide on the surface because of the presence of oxygen, the reaction between hydrofluoric acid and silicon oxide is as follows:

SiO₂+6HF→2H⁺+SiF₆²⁻+2H₂O (1)

However, it should be noted that although the Si—F bond is thermodynamically favoured over the Si—H bond, the latter prevails at the surface because of the strong polarisation of the Si^{δ+}F^{δ-} bonds which form as soon as the reaction between the surface of the substrate 2 and the hydrofluoric acid begins. The said Si^{δ+}F^{δ-} bonds weaken the Si—Si bonds in the layers of substrate 2 lying below the said surface, rendering them more vulnerable to nucleophilic attack by hydrofluoric acid according to the following reaction:

Si_{bulk}—Si——Si^{δ+-}F^{δ-}+4HF→Si_{bulk}—Si—H+SiF₄ (2)

where Si_{bulk}—Si—Si^{δ+}F^{δ-} represents the substrate 2, the surface of which has already been attacked by the hydrofluoric acid with a consequent formation of Si^{δ+}F^{δ-} bonded to said surface. The term Si_{bulk} represents the portion of the substrate 2 lying below the surface layer.

The reaction of more hydrofluoric acid with this surface layer yields Si_{bulk}—Si—H (a layer of hydrogenated silicon) as a product, and leads to the formation of SiF₄, a volatile molecule which moves away from the substrate 2.

Immersion, 102c, of the substrate, which now has a surface layer of hydrogenated silicon, in the solution of silver or gold salt leads to the formation of silver or gold nanospheres respectively.

Two electrochemical reactions which bring about oxidation of the silicon and reduction of the silver or gold respectively take place close to nanolenses 4a, 4b and 4c:

Si+2H₂O→SiO₂+4H⁺+4e⁻ (3)

Ag⁺+e⁻→Ag⁰ (4)

or, in the case of gold:

Au³⁺+3e⁻→Au⁰ (5)

The nitrogen does not react, but remains in solution as NO₃⁻. As far as substrate 2 is concerned, the surface layer of hydrogenated silicon reacts initially, and subsequently the silicon in the underlying layers Si_{bulk} also reacts.

Half reactions (3)-(4), which together represent an oxidation/reduction reaction, take place thanks to their potential difference. The standard oxidation/reduction potentials of reactions (3) and (4) are:

E₀_{_{—}}_{reaction3}=−0.9 V

E₀_{_{—}}_{reaction4}=0.8 V

Starting from standard oxidation/reduction potentials it is possible to calculate the equilibrium constant Kₑ for the oxidation/reduction reaction using Nernst's equation:

$$ln {K}_{e} = \frac{nF Δ E}{RT}$$

where n is the number of electrons transferred in the oxidation/reduction reaction, F is Faraday's constant, and T is the temperature at which the reaction takes place.

In the reaction forming silver nanospheres the temperature is preferably within the range 45-50° C.

The mechanism for the formation of silver nanospheres takes place initially through an Ag⁺ ion in the vicinity of the silicon surface capturing an electron from the valency band of the silicon itself and becoming reduced to Ag⁰. The silver nucleus so formed, being highly electronegative, tends to attract other electrons from the silicon, thus becoming negatively charged and thus catalysing the reduction of other Ag⁺ ions, which enlarge the bead. The reaction must therefore then be blocked, removing the other available silver ions, by washing in deionised water, and/or by reducing the temperature, thus rendering the process thermodynamically unfavourable.

In the case of the pair of half-reactions (3) and (5) the standard oxidation/reduction potentials are:

E₀_{_{—}}_{reaction3}=−0.9 V

E₀_{_{—}}_{reaction5}=1.52 V

The reaction mechanism is similar to that for silver, but the reaction kinetics are different in that gold reacts forming a larger number of particles of smaller size than does silver. For this reason the reaction time during the nanosphere formation stage has to be increased in order to completely fill nanolenses 4a, 4b and 4c.

In the reaction in which gold nanospheres are formed, the temperature preferably lies within the range 40-50° C.

Clearly, while not changing the principle of the invention, its embodiments and the details thereof may be varied widely from what has been described and illustrated purely by way of a non-limitative example, without thereby going beyond the scope of protection of this invention defined by the appended claims.

1. Method for manufacturing an optical detection device comprising: the operation of producing a plurality of metal nanospheres on a substrate;
producing on the said substrate a plurality of lithographic nanostructures capable of receiving the metal nanospheres,
performing a self-aggregative deposition of at least one metal in such a way as to create a respective metal nanosphere in each lithographic nanostructure.

2. Method according to claim 1, wherein the operation of producing a plurality of lithographic nanostructures comprises the step of performing a high resolution electronic lithography to produce a plurality of nanolenses.

3. Method according to claim 2, in which the operation of producing the said nanolenses comprises the step of aligning the nanolenses along a predetermined direction.

4. Method according to claim 3, in which the operation of producing the said nanolenses comprises the step of spacing out the nanolenses from one another, along the said direction, of respective mutual distances of decreasing size.

5. Method according to claim 1, in which the operation of performing self-aggregative deposition comprises the operations of:
immersing the substrate in a solution of hydrofluoric acid,
immersing the substrate in a solution of the at least one metal.

6. Method according to claim 5, further comprising the operation of washing the substrate in deionised water.
